(19) United States
(12) Patent Application Publication
(10) Pub. No.: US 2026/0300551 A1
(43) Pub. Date: Oct. 1, 2026

(54) DATA VERIFICATION AND PROTECTION SCHEME

(71) Applicant: TEXAS INSTRUMENTS INCORPORATED, Dallas, TX (US)

(72) Inventors: Naveen Narayanan, Bangalore (IN); Nitesh Mishra, Bengaluru (IN)

(21) Appl. No.: 19/089,673

(22) Filed: Mar. 25, 2025

(51) Int. Cl. G06F 21/64; G06F 21/55; G06F 21/79

(52) U.S. Cl. CPC G06F 21/64; G06F 21/556; G06F 21/79

(57) ABSTRACT

Devices and methods for data verification and protection are described. Data (security data) read from a write-restricted memory to a security chain/set of registers may need to be protected and verified. Various data patterns which are independent of security data may be generated and multiplexed with security data to be transmitted to security chain. The data patterns read from security chain may be compared to the data patterns generated to verify whether the data patterns stored in security chain are correct. A match or a mismatch of the data patterns may provide an indication of whether security data is correctly stored in security chain. A data signature of security data may also transmit to and read from security chain to compare to the data signature stored in the write-restricted memory to provide another indication. A processor may receive the indications and execute appropriate instructions to provide enhanced data protection.

### BACKGROUND

Devices that handle sensitive data may include security measures to protect against threats. One implementation to secure a device is to store security data such as security keys, identifiers, and/or configuration data in a memory that may not be altered easily. For example, the device may read the contents of the memory that may not be altered easily to boot as a highly secure device with no accessibility to sensitive data. However, an intruder may gain access to sensitive data when the security data is being read from the memory to the device by altering the security data in transmission.

### SUMMARY

Disclosed herein is technology, including systems, methods, and devices, for data verification and protection. Many embodiments of this disclosure include a device. The device may include a processor, a memory controller, a pattern generator, and a pattern checker. The memory controller may read the security data stored in a write-restricted memory (e.g., security keys and/or configuration data), either internal or external to the device upon receiving a read request from the processor. The pattern generator may generate sets of data patterns, which are independent of contents of the security data. The security data and the data patterns may be multiplexed as chain data to transmit via a security chain/channel/set of registers. The pattern checker may receive the data patterns via the security chain, and determine whether the data patterns loaded on the security chain match the data patterns generated by the pattern generator. If a match exists, the pattern checker may provide a first indication of the security data being stored correctly in the security chain to the processor. If a match does not exist, the pattern checker may provide the first indication as the security data not being stored correctly in the security chain to the processor. A data signature of the security data may be stored in the write-restricted memory and transmitted by the memory controller to the security chain before the chain data is transmitted. The memory controller may receive the data signature back from the security chain and verify whether the data signature read from the security chain match the data signature stored in the write-restricted memory. The memory controller may provide a second indication of the security data stored correctly in the security chain to the processor. The processor may execute instructions in response to receiving the first and second indications of whether the security data being stored correctly in the security chain.

Many embodiments of this disclosure include a method of verifying data during transmission. The method may include reading the security data from a memory (e.g., write-restricted memory) by the memory controller. The method may also include transmitting the security data to the processor via a security chain/set of registers/channel by the memory controller. The method may further include generating and transmitting sets of data patterns to the security chain by the pattern generator. The security data and the data patterns may be multiplexed to be transmitted to the security chain. The method may further include reading/receiving the data patterns stored in the security chain by the pattern checker. The method may include determining whether the data patterns loaded in the security chain match the data patterns generated by the pattern generator by the pattern checker. The method may include transmitting by the pattern checker an indication of whether the security data being stored correctly in the security chain based on whether the data patterns stored in the security chain match the data patterns generated by the pattern generator. The processor may receive the indication directly or receive the indication through logic gates (e.g., an AND gate), and execute instructions in response to the indication.

This summary is provided to introduce a selection of concepts in a simplified form that are further described below in the technical disclosure. It may be understood that this summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a device implementing the data verification scheme in accordance with many embodiments.

FIG. 2 illustrate further details of including a shift register for the data verification scheme in accordance with many embodiments.

FIG. 3 illustrates a flow chart of a process for verifying data in accordance with many embodiments.

The same reference numbers or other reference designators are used in the drawings to designate the same or similar (functionally and/or structurally) features.

### DETAILED DESCRIPTION

As described above, an intruder may try to gain access to sensitive data in a device by altering security data, such as configuration data and security keys, that would otherwise inhibit the access of the sensitive data while the security data is being read from a memory to the device. The memory with the security data stored may not be easily altered. In many embodiments, the memory may be a write-restricted memory, such as a Read Only Memory (ROM), a one-time-programmable ROM, or a non-volatile memory with write-access controls.

In some examples, the write-restricted memory may include electronic fuses (eFuse) ROM. The eFuse ROM may include memory cells, and a memory cell may store a bit. In some examples, a memory cell includes an eFuse (e.g., a fusable link such as a tiny metal wire) coupled between an select input of the memory cell and ground, and an output, where the stored bit is read, coupled to the select input. The eFuse is conducting when intact. When the eFuse is blown, the eFuse may not conduct (e.g., wire is damaged due to electromigration). When the memory cell is selected to be read, a read voltage may be applied to a select input. If the eFuse is intact and conducting, the fusable link may pull an output coupled to the read voltage down to ground and the memory cell may output 0. However, if the fusable link in the eFuse is blown, the output may remain at the read voltage and the memory cell may output 1. The eFuse ROM may be programmed by selectively blowing a subset of the eFuses, and those memory cells with blown eFuses may output 1. Whether due to physical damage or another mechanism, those eFuses that are blown may not be reverted back to their conducting state, and thus those memory cells may not output 0 after being programmed. Therefore, the eFuse ROM may not be written to after the ROM has been programmed.

During development and deployment, it may be desirable for devices to boot in test mode with security features disabled and debug test ports enabled under many circumstances. Prototype devices may boot in test mode to be validated to ensure functionality. Production devices may also boot in test mode to check for defects at the manufacturer prior to shipping to end users. In those circumstances, the write-restricted memory in devices may not be programmed, and hence the security data stored in the write-restricted memory may include a code that disables a variety of safeguards that would be in place when the device is delivered to end users. For example, some devices may be configured to give users full access when a code of all 0s (zeros) is read from the write-restricted memory. Once the write-restricted memory is programmed with new security data that overwrites the code, the same devices may boot based on the new security data and thereby prevented from entering the test mode with the safeguards disabled.

The security data may be read from the write-restricted memory via a channel/connection/electrical path. An intruder with a device that is specifically configured to prevent test mode may try to force a pattern (e.g., all 0s) on the channel/connection/electrical path during data transmission that mimics the code in order to enter test mode and thereby disable the safeguards regardless of the configuration in the write-restricted memory. For example, even though the security data in the write-restricted memory is not 0s, the device may mistakenly read 0s as the security data and boot in test mode, giving the intruder access to sensitive data. Many embodiments of this invention are described in detail below to address the problem as described above.

The functionality of various systems, modules, circuits, devices or components described herein may be implemented as hardware, firmware, and/or software or a combination thereof, depending on the application requirements.

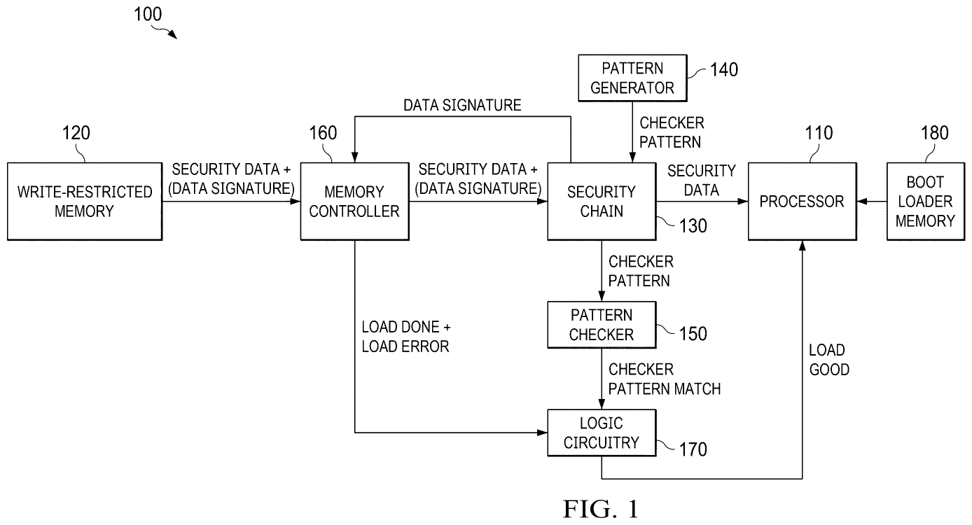

FIG. 1 is a block diagram of a device in accordance with many embodiments of this invention. The device 100 shown in FIG. 1 may be a system-on-chip (SOC) or any other integrated circuit device that may be configured to handle sensitive data. In many examples, the device 100 includes a processor 110, a write-restricted memory 120, an memory controller 160, an security chain 130, a pattern generator 140, and a pattern checker 150. The processor 110 may include one or more microcontrollers, microprocessors, digital signal processor cores, or any other general purpose or application specific processors.

The write-restricted memory 120 may store security data, such as secure boot/encryption keys, unique IDs, and configuration data. A portion of the write-restricted memory 120 or another write-restricted memory may also store valuable data which does not relate to boot settings (e.g., end user security keys). The valuable data may not be user accessible (e.g., the data is usable by the processor 110 and/or other circuitry but is not permitted to be output to the user) if the device 100 boots with correct security settings based on the security data. However, if the intruder successfully boots the device 100 in test mode, the intruder may also gain access to valuable data.

The write-restricted memory 120 may include any non-volatile electrical, or magnetic media, such as read-only memory (ROM), non-volatile RAM with encryption, or any other digital/analog media that is write-restricted. The write-restricted memory 120 may be programmed at the manufacturer, system integrator, or anywhere along the chain to the end user, and may be prevented from being further modified after it is programmed.

In many embodiments, when power supplied to the device 100 exceeds certain threshold, the device 100 may start a boot process. Additionally or in the alternative, the device 100 may receive an external reset signal which may cause the device 100 to reset. Certain circumstances (e.g., errors executing certain instructions) may cause the device 100 to reset. The device 100 may reset by terminating all instructions, flushing contents of cache memories, and repeating the boot process. When the device 100 start a boot process from reset, contents of non-volatile memories may not have been flushed. The intruder who may force the device 100 in test mode from reset may also gain access to valuable data stored in non-volatile memories.

The boot process may include many steps, such as executing the initialization code stored in one or more memories (boot loader memory 180), which may include the write-restricted memory 120, another internal/external ROM, a flash memory, a random-access memory (RAM) or any other volatile or non-volatile memories. For example, the boot loader memory 180 may be an internal ROM in the device 100, or an external flash memory. The processor 110 may execute the code stored in the boot loader memory 180 to initialize various hardware/software in device 100, such as clock configuration and memory mapping.

In many examples, the processor 110 may request the security data from the write-restricted memory 120 to be written to the Security chain 130 during the boot process to boot accordingly. To receive the security data, the processor 110 may transmit a read request to the memory controller 160. The memory controller 160 may include a memory controller that read/write from/to memory respectively in response to read/write requests received from the processor 110. The read requests may include indications of data source and data destination. For example, a read request may include indications that the data source is the write-restricted memory 120. The read request may further indicate that the data read from the write-restriction memory 120 may be transmitted to the security chain 130. The memory controller 160 may receive the read request and transmit the security data to the security chain 130. In many embodiments, the security chain 130 may include a set of registers, where the security data may be transmitted to and stored at. The processor 110 and/or other components of the device 100 may read the security data from the security chain 130, and in some embodiments, the registers of the security chain 130 are arranged as memory-mapped registers. In other examples, the security chain 130 may be any connections/channels/electrical media that transfers data between the memory controller 160 and the processor 110.

The pattern generator 140 may generate sets of bits as checker patterns. The security data from the write-restricted memory 120 and the checker patterns may be multiplexed as chain data to be stored in the security chain 130. For example, the security data may be an 8-bit data, in binary 1101 0011. The pattern generator 140 may insert a 3-bit checker pattern, 101, after the least significant bit of the security data, a 4-bit checker pattern 1010 before the fourth least significant bit of the security data, and a 1-bit checker pattern 1 after the most significant bit of the security data. As a result, the chain data provided to the security chain 130 is the original 8-bit security data multiplexed with the checker patterns, which is now 1(1)10 1(101 0)001 1(101) (bits in parenthesis are check patterns). The above example uses 8-bit security data and a total of 8-bit checker patterns. The security data and checker patterns may include any combinations of 1s and 0s and may include any number of bits, and checker patterns may be inserted anywhere in the chain data which is provided to the security chain 130.

The pattern generator 140 may generate checker patterns in various different ways, and the pattern checker 150 may compare and determine whether the checker patterns that are generated match the checker patterns loaded on the security chain 130. The checker patterns generated may be independent of contents of the security data. In many examples, the pattern generator 140 may generate fixed checker patterns. The pattern checker 150 may be programed with the fixed checker patterns. Using the above example, the pattern generator 140 generates three fixed checker patterns, 101, 1010, and 1, when the security data is read via the security chain 130. The pattern checker 150 may be programmed to check for 101, 1010, and 1 stored in the appropriate locations of the security chain 130.

Alternatively, the pattern generator 140 may generate a set of random checker patterns and provide the checker patterns to the pattern checker 150 for use in verifying the contents of the security chain 130. For example, the pattern generator 140 may generate 101, 1010, and 1 when the security data is requested by the processor 110. The pattern generator 140 may transmit 101, 1010, and 1 to the pattern checker 150, and the pattern checker 150 may verify if checker patterns are 101, 1010, and 1 stored in the appropriate locations of the security chain 130 when the chain data is loaded on the security chain 130. When the security data is requested by the processor 110 again, the pattern generator 140 may generate another set of random checker patterns as 11, 0011, and 0. The pattern generator 140 may again transmit 11, 0011, and 0 to the pattern checker 150, so that the pattern checker 150 may verify the copies of the checker patterns stored in the appropriate locations of the security chain 130.

In another example, the pattern generator 140 and the pattern checker 150 follow the same algorithm/sequence of generating/verifying the checker patterns. For example, the pattern generator 140 may start with a base value as a first set of checker patterns and increment the value linearly of the first set of checker patterns to generate subsequent sets of checker patterns, such as incrementing 1 to the previous checker patterns next time the security data is requested to be read via the security chain 130. For example, the pattern generator 140 may generate 0, 01, and 0010 (value 0, 1, and 2, base value) the first time the security data is requested to be read via the security chain 130. The pattern checker 150 may be programed with the base value of the checker patterns. Thus, the pattern checker 150 may check for 0, 01, and 0010 on the security chain 130 without the pattern generator 140 providing the checker patterns generated to the pattern checker 150. When the security data is again requested to be read via the security chain 130, the pattern generator 140 may generate 1, 10, and 0011 (value 1, 2, and 3, increment the value of the previous checker pattern by 1). The pattern checker 150 may be programed to follow the same sequence of checker pattern generation, and in this example, the pattern checker 150 may increment the value of the previous checker pattern by 1, and check for 1, 10, and 0011 stored at the appropriate locations of the security chain 130.

The pattern checker 150 may receive the checker patterns stored in the security chain 130 to verify if any mismatches exist between the checker patterns generated by the pattern generator 140 and the checker patterns stored in the security chain 130. The pattern checker 150 may couple to the security chain 130 at appropriate locations where the checker patterns are stored, but not couple to the security chain 130 at locations where the security data are stored. Using the example above, 3-bit checker pattern, 101, is inserted after the least significant bit of the security data, a 4-bit checker pattern 1010 is inserted before the fourth least significant bit of the security data, and a 1-bit checker pattern 1 is inserted after the most significant bit of the security data. The chain data provided to the security chain 130 may be 1(1)10 1(101 0)001 1(101). The three least significant bits of the chain data is the inserted checker pattern 101, the eighth, ninth, tenth, and eleventh least significant bits of the chain data is the inserted checker pattern 1010, and the second most significant bit of the chain data is the inserted checker pattern 1. The pattern checker 150 may couple to the security chain 130 at locations where those checker pattern bits are stored. More details on how the pattern checker 150 may couple to the security chain 130 are described later.

After the pattern checker 150 verifies the checker patterns stored in the security chain 130, the pattern checker 150 may transmit a pattern match signal to the processor 110 to indicate whether the checker patterns stored in the security chain 130 match the checker patterns generated by the pattern generator 140. The pattern checker 150 may provide an indication (e.g., 1) on the pattern match signal if the checker patterns stored in the security chain 130 match the checker patterns generated by the pattern generator 140. The pattern checker 150 may provide an indication (e.g., 0) on the pattern match signal if the checker patterns does not match. Even though the checker patterns may be independent of the security data, whether the checker patterns generated match the checker patterns stored in the security chain 130 provides an indication of whether the security data stored in the security chain 130 is correct. The processor 110 may prevent the device 100 from booting in test mode (or, in some examples, from booting at all) upon receiving the indication (e.g., 0) that checker patterns generated does not match the checker patterns stored at the security chain 130 on the pattern match signal. If the intruder forces a pattern (e.g., all 0s) into the security chain 130 in a manner that bypasses the checker patterns, the pattern checker 150 may receive checker patterns stored in the security chain 130 as all 0s, and detect a mismatch between checker patterns generated and checker patterns received. The pattern checker 150 may transmit an indication of checker pattern mismatch to the processor 110, and the processor 110 may subsequently prevent the device 100 from booting in test mode, even though the falsified security data present in the chain data as read from the security chain 130 indicates test mode is permitted.

The memory controller 160 may detect when the chain data has been loaded to the security chain 130 and may also detect whether data loaded to the security chain 130 has been compromised using Error Correction Code (ECC), Cyclic Redundancy Check (CRC), or any other computations/techniques that checks and/or corrects for errors during data transmission (referred as data signature from here on). The data signature may be generated by applying a certain function to the contents of the security data. In many examples, the write-restricted memory 120 may store a data signature of the security data. The data signature stored in the write-restricted memory 120 may represent the security data. The data signatures may be encoded in several different ways to represent a set of data, and when one or more bits of the set of data change from a 0 to a 1, or a 1 to a 0, the data signatures may change accordingly. The data signature of the security data may be transmitted to the security chain 130 before the chain data is transmitted.

The data signature and checker pattern may serve complimentary functions. The data signature may ensure that the security data as read from the write-restricted memory 120 and stored in the security chain 130 is correct. However, in many examples, because the device 100 is intended to function when the entire contents of the write-restricted memory 120 including the data signature is unprogrammed (e.g., 0), then a data signature of all zeros may be a valid data signature. Because the checker pattern is generated by the pattern generator 140 instead of being read from the write-restricted memory 120, it may not be bound by such a requirement. In fact, the checker pattern may be completely independent of the contents of the write-restricted memory 120. Thus, the checker pattern may ensure that the contents of the security chain 130 were loaded in the proper manner regardless of the contents of the write-restricted memory 120.

The memory controller 160 may transmit a load done signal to the processor 110 when the data signature of the security data and/or the chain data (security data read from the write-restricted memory 120 multiplexed with checker patterns) are loaded on the security chain 130. The memory controller 160 may count to the number of the clock cycles for the data signature of the security data and/or the chain data to be finished loading to the security chain 130 to transmit the load done signal. For example, the data signature may be 4-bit long, the security data may be 8 bits long, and a total of 8 bits of checker patterns may be inserted, thus, the chain data that may be loaded on the security chain 130 is 20 bits long. If loading 1 bit to the security chain 130 takes 1 clock cycle, loading 4 bits of the data signatures and 16 bits of the chain data to the security chain 130 may take 20 clock cycles. The memory controller 160 may count to 20 clock cycles and may transmit the load done signal to the processor 110 at the end of the 20 clock cycles. Alternatively, if the data signature of the security data is not loaded to the security chain 130, and the security data and the checker patterns are loaded to the security chain 130, the memory controller 160 may count to 16 clock cycles to transmit the load done signal to the processor 110.

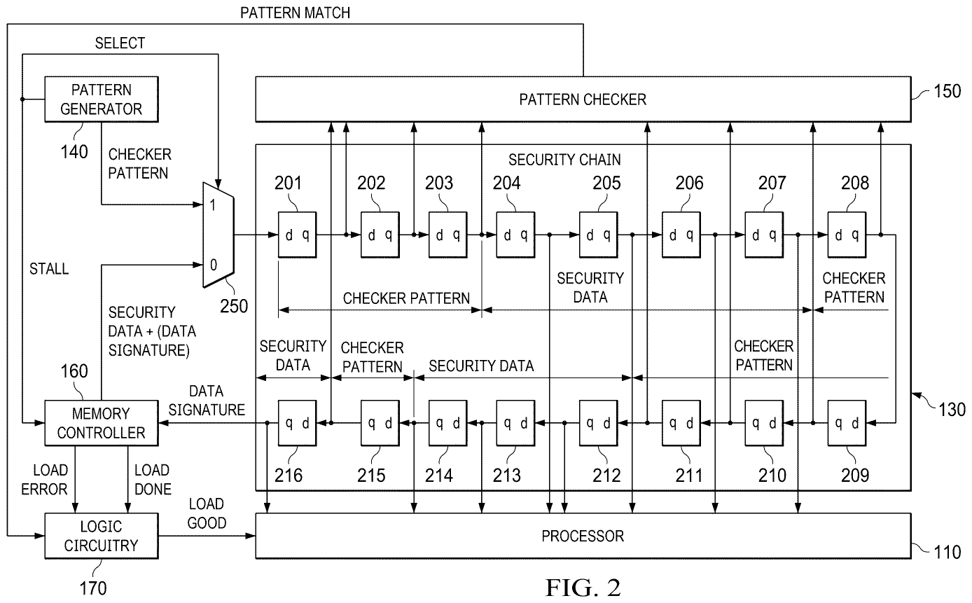

The memory controller 160 may also couple to the security chain 130 to detect whether data loaded to the security chain 130 has been comprised. The security chain 130 may include a shift register. The most significant bit or the least significant bit of the data signature of the security data may be the first bit loaded to the security chain 130. The chain data may start loading with its most/least significant bit to the security chain 130 after the data signature of the security data has been loaded. As more data is loaded the security chain 130, the first bit loaded (most/least significant bit of the data signature of the security data) may be shifted down along the security chain 130. How bits in the chain data are loaded to and shifted down the security chain 130 are described later in more details with respect to FIG. 2. The memory controller 160 may couple to the end of the security chain 130 to receive the data signature of the security data before receiving the first bit (the most/least significant bit) of the chain data. More details of how the memory controller 160 couples to the security chain 130 are described later. For example, the data signature of the 8-bit security data (1101 0011) may be 4 bits long (the 2 least significant bits of the data signature may record how many 1s are in the 4 least significant bits of the security data, and the 2 most significant bits of the data signature may record how many 1s are in the 4 most significant bits of the security data). In this example, the data signature may be 1110. The chain data (the security data multiplexed with checker patterns) being loaded to the security chain 130 may be 1110 1101 0001 1101. The memory controller 160 may receive the first bit of the data signature when the thirteenth bit of the chain data is being loaded to the security chain 130. When the memory controller 160 transmits the load done signal, the memory controller 160 may have received all 4 bits of the data signature and the first bit (the most/least significant bit) of the chain data. The memory controller 160 may verify whether the data signature received from the security chain 130 matches the data signature transmitted. The memory controller 160 may also verify whether the first bit of the chain data received from the security chain 130 match the first bit of the chain data transmitted. For example, the most significant bit of the chain data (1) may be first loaded to the security chain 130. If the memory controller 160 receives 1110 (the data signature) and 1 (most significant bit of the chain data), which matches the data signature transmitted and the most significant bit of the chain data, the memory controller 160 may provide an error free indication (e.g., 1) on the load error signal. If the memory controller 160 does not receive 1110 and 1, the memory controller 160 may provide an error active indication (e.g., 0) on the load error signal. Alternatively, the memory controller 160 may verify the data signature, but not verify the first bit of the chain data. In many other examples, the write-restricted memory 120 may not store the data signature of the security data, and/or the memory controller 160 may check the first bit of the chain data, but not the data signature to verify whether data loaded to the security chain 130 has been compromised.

The three status signals, load done signal, the load error signal, and the pattern match signal may be transmitted to a logic circuitry 170, for example, an AND gate. The output of the logic circuitry 170 may couple to the processor 110 and transmit a load good signal in response to the status signals to the processor 110 to indicate if the chain data (the security data and the checker patterns) is loaded to the security chain 130 correctly. For example, the load done signal may remain logic low (0) since power on, and the memory controller 160 may provide an indication (e.g., 1) on the load done signal when the chain data is done loading to the security chain 130. The load error signal may be an active low signal and may remain logic high (1) since power on. When an error is detected, the memory controller 160 may provide an indication (e.g., 0) on load error signal. If no errors detected, the load error signal may remain 1. The pattern match signal may remain 0 since power on. The pattern checker 150 may transmit a provide an indication (e.g., 1) on the pattern match signal when a match is verified between the generated checker patterns and the checker patterns loaded on the security chain 130. If a mismatch is found, the pattern match signal may remain 0. The output of the logic circuitry 170 may be 0 since power on, and remain 0 if any of the status signals transmitted to the logic circuitry 170 is 0. When all three of the status signals are 1s, the output of the logic circuitry 170 may provide an indication (e.g., 1) on the load good signal to the processor 110 indicating the loading of the chain data on the security chain 130 is completed and error free. Alternatively, the processor 110 may receive the three status signals individually and prevent the device 100 to boot in test mode based on the three status signals received. Various different logic may be implemented as described above in hardware/software, internal/external to the processor 110 to indicate to the processor 110 of loading complete and/or loading errors in response to one or more of the status signals as described herein.

The processor 110 may receive the load good signal. In many examples, the processor 110 may receive an indication (e.g., 1) on the load good signal, indicating that loading of the chain data is completed and error free. The processor 110 may read the security data stored in security chain 130 at boot and later during normal operation. For example, at boot, the processor 110 may read the security data to determine whether to boot with security features enabled or disabled. If the processor 110 receives an indication of loading errors/incomplete (e.g., 0) on the load good signal, the processor 110 may not proceed to read the security data from the security chain 130, and/or the processor 110 may further abort the boot process, such as stopping a clock, and/or assert a system reset signal to stall any subsequent instructions from executing and/or stop other devices connected from booting. In this regard, even if the intruder successfully forces 0s as chain data loaded on the security chain 130, the pattern checker 150 may detect a mismatch between the checker patterns (combinations of 1s and 0s) generated by the pattern generator 140 and the checker patters on the security chain 130. The pattern checker 150 and/or the memory controller 160 (via the logic circuitry 170) may provide an indication of loading errors/incomplete (e.g., 0) on the load good signal, and the processor 110 receiving the indication on the load good signal, may stall the device 100 from booting, and thus giving no access to the intruder, and providing enhanced protection to sensitive data.

FIG. 2 is a block diagram illustrating details on including shift registers in the security chain 130 in accordance with many embodiments of this invention. An example security chain 130 includes a 16-bit long shift register. As shown in FIG. 2, the 16-bit shift register may include 16 flip flops 201-216 coupled serially. The security data may be loaded on a first subset of the flip flops 201-232 (e.g., flip flops 204-207, 212-214, and 216), and the checker patterns may be loaded on a second subset of the flip flops 201-2016 (e.g., flip flops 201-203, 208-211, and 215). Although only 16 bits are shown, the same principles apply to any number of flip flops (and likewise any number of bits). In some example, the shift register includes D flip flops, although other examples may include any other suitable type of data storage circuit.

A mux 250 may multiplex the security data and the checker patterns to load into their respective flip flops. The memory controller 160 may read the security data from the write-restricted memory 120 and may transmit the security data to one of the inputs of the mux 250, for example input 0. The pattern generator 140 may transmit the generated checker patterns to another input of the mux 250, for example input 1. The pattern generator 140 may transmit a select signal to the select pin of the mux 250 to select when and which input to transmit on the output of the mux 250 to the security chain 130. A 0 on the select signal may select a bit of a checker pattern provided by the memory controller 160 received at input 0 to transmit via the output of the mux 250 to the security chain 130, and a 1 on the select signal may select a bit of security data provided by the pattern generator 140 received at input 1 to transmit to the security chain 130. Using the example above where the chain data is 1110 1101 0001 1101, the 1-bit checker pattern (1) is inserted after the most significant bit of the security data (1101 0011). If the most significant bit of the chain data is loaded to the security chain 130 as a first bit, the first two bits of the chain data to be loaded to the security chain 130 is 1(1) (bit in parenthesis is the inserted checker pattern) in this example. In many examples, the mux 250 takes one clock cycle to transmit one bit from the selected input to output. The pattern generator 140 may transmit a 0 on the select signal to the mux 250 for 1 clock cycles, so input 0 of the mux 250 (the memory controller 160) transmit 1 bit of the security data (1) to the security chain 130. The pattern generator 140 may transmit a 1 on the select signal to the mux 250 for the next clock cycle, and hence selects the pattern generator 140 (input 0 of the mux 250) to output the 1-bit checker pattern (1) to the security chain 130. Alternatively, the memory controller 160 may transmit the select signal to the mux 250 to select between input 0 or input 1, in the similar manner as described above.

The memory controller 160 and the pattern generator 140, however, may advance 1 bit per clock cycle regardless of the select signal of the mux 250. Using the example above, when input 0 (the memory controller 160) of the mux 250 is selected for 1 clock cycle, the pattern generator 140 (input 1 of the mux 250) may also transmit the 1-bit checker pattern, which is 1, even though input 1 is not selected. When input 1 is selected after the first clock cycle, the pattern generator 140 may start transmitting the next checker pattern, the 4-bit checker pattern (1010). The chain data, in this regard, may be 1101 0101, instead of 1110 1101 0001 1101. To address this issue, many embodiments in accordance with this disclosure are described herein.

For alignment, the security data may be padded with bits that are to be overwritten by the bits of the checker pattern(s). The pad bits may be stored in the write-restricted memory 120 as part of the security data or the memory controller 160 may add the pad bits into the security data where the checker patterns are to be inserted. For example, the pattern generator 140 may pad the checker patterns with 0s or 1s where the security data is in the chain data. Using the example above, the chain data is 1(1)10 1(101 0)001 1(101). The memory controller 160 may insert 0s to the security data where the checker patterns may be inserted, thus the padded security data is 1(0)10 1(000 0)001 1(000). Similarly, the pattern generator 140 may insert 0s where the security data may be. In this example, the padded checker patterns at input 1 of the mux 250 may be 0(1)00 0(101 0)000 0(101). The padded checker patterns and the padded security data may be the same length. In this regard, the inputs (the padded security data and the padded checker patterns) of the mux 250 may still advance 1 bit per clock cycle, but since the input data are padded with 0s where the inputs are not selected, the resulting chain data loaded to the security chain 130 may be as desired, 1(1)10 1(101 0)001 1(101). In another example, the security data with pad bits (represented by “X”) may be stored in the write-restricted memory 120. Using the above example, the security data may be 1(X)10 1(XXX X)001 1(XXX) as stored in the write-restricted memory 120. The checker patterns as stored in the pattern generator 140 may be X(1)XX X(101 0)XXX X(101). X may be any combination of 1s or 0s that is suitable. In similar regard as described above, the padded security data and the padded checker patterns may be provided to the mux 250 by the memory controller 160 and the pattern generator 140 respectively to load the security chain 130 with desired chain data.

Alternatively, the pattern generator 140 may transmit a stall signal to the memory controller 160 to stop the memory controller 160 from advancing bits of the security data when input 0 of the mux 250 is not selected. Using the above example with 8-bit security data inserted with a total of 8 bits of checker patterns, the chain data to be loaded to the security chain 130 may be 1(1)10 1(101 0)001 1(101). Instead of padding the security data and the checker patterns with 0s, the pattern generator 140 may transmit the stall signal to the memory controller 160 by forwarding the select signal. In this example, at clock cycle 1, the pattern generator 140 may transmit a 0 on the select signal to the mux 250 for 1 clock cycles to select the most significant bit of the security data to transmit to the security chain 130. At the same time, the pattern generator 140 may forward the select signal also to the memory controller 160 as the stall signal. Upon receiving a 0 on the stall signal, the memory controller 160 may transmit the most significant bit of the security data to the input 0 of the mux 250, while the pattern generator 140 may not transmit any checker patterns. At clock cycle 2, the pattern generator 140 may transmit a 1 on the select signal to the mux 250, selecting input 1 (the pattern generator 140), and may also forward the select signal as the stall signal to the memory controller 160. The memory controller 160 may receive the 1 on the stall signal and may not transmit the remaining security data to the input 0 of the mux 250 at clock cycle 2. So, at clock cycle 2, the select signal/the stall signal may be 1 and the memory controller 160 may not transmit the second most significant bit to the security chain 130, while the pattern generator 140 may transmit the 1-bit checker pattern (1) to input 1 of the mux 250. The 1-bit checker pattern may thus be loaded to the security chain 130 via the output of the mux 250 at clock cycle 2. In this regard, the correct chain data may be loaded to the security chain 130.

In many embodiments that the write-restricted memory 120 may also store the data signature of the security data and the memory controller 160 may transmit the data signature before the chain data is transmitted to the security chain 130, similar implementations as described above may be implemented. Using the above examples, the data signature is 4 bits long. If the pad bits are used, data from the memory controller 160 may be 1110 1(X)10 1(XXX X)001 1(XXX), and data from the pattern generator 140 may be (XXXX) X(1)XX X(101 0)XXX X(101). The pattern generator 140 may select appropriate inputs of the mux 250 for appropriate clock cycles to load data from the memory controller 160 and the pattern generator 140 to the security chain 130 through the mux 250. Using the same example, the pattern generator 140 may select input 0 of the mux 250 for the first 4 clock cycles to load the data signature through the output of the mux 250 to the security chain 130. If stalling advancement of bits is used, the pattern generator 140 may transmit appropriate number of clock cycles of 1s or 0s on the select/stall signal to select/stall either the pattern generator 140 or the memory controller 160 to advance/stall bits respectively. Using the same example, the pattern generator 140 may transmit a 0 for the first 4 clock cycles so input 0 of the mux 250 is selected and the memory controller 160 may provide the data signature to the output of the mux 250, and pattern generator 140 may stall checker patterns from advancing for 4 clock cycles.

In embodiments in which the memory controller 160 transmits the select signal to the mux 250, the memory controller 160 may also forward the select signal to the pattern generator 140 to stop the pattern generator 140 from advancing checker bits when input 1 is not selected in the similar manner as described above. Even though the disclosure describes the select signal sent from either memory controller 160 or the pattern generator 140, but in other examples, other components in device 100 may transmit the select signal to the mux 250 to multiplex the security data and the checker patterns as desired.

As illustrated by FIG. 2, the security chain 130 may include a shift register. The shift register may include a set of flip flops 201-216 connected in series, the output of the previous flip flop connecting to the input of the next flip flop. For example, the output of the flip flop 211 is connected to the input of the flip flop 212. The output of the mux 250 may couple to the input of the first flip flop 201 in the security chain 130. The flip flops 201-216 may share a clock. The chain data (the security data and the checker patterns) may start loading to the security chain 130 by loading the most significant bit of the chain data to the input of the first flip flop 201, followed by the second most significant bit at the next clock cycle, so on and so forth. The bit loaded at the first flip flop 201 may shift down to the next flip flop per clock cycle. As the shared clock continues, bits of the chain data may load to the first flip 201, and may shift down the security chain 130 until the chain data is loaded to the security chain 130.

For example, the most significant bit of the chain data may be output from the mux 250 and be loaded to the Data (D) input pin of the first flip flop 201 at clock cycle 0. At clock cycle 1, the second most significant bit may be output from the mux 250 and be loaded to the D input pin of the first D flip flop 201. The most significant bit is shifted to the Q output pin of the first flip flop 201 also at clock cycle 1. The D input pin of the second flip flop 202 may also receive the most significant bit at clock cycle 1 since the D input pin of the second D flip flop 202 is connected to the Q output pin of the first flip flop 201. At clock cycle 2, the most significant bit may be shifted down to the Q output pin of the second flip flop 202, and also at the D input pin of the third flip flop 203. The second most significant bit may be at the Q output of the first flip flop 201, and the D input of the second flip flop 202. The third most significant bit may be loaded to the input of the first flip flop 201.

Bits of the chain data may shift down the flip flops 201-216 in the above described manner. The mux 250 may output the most significant bit of the chain data to the security chain 130 first at clock cycle 0 or the least significant bit first to the security chain 130 at clock cycle 0. In the examples illustrated by FIG. 2, the security chain 130 includes 16 D flip flops 201-216. If a bit shifts down one flip flop per clock cycle, at clock cycle 16, the most/least significant bit may be shifted to the Q output pin of the last flip flop 216 of the security chain 130, while the least/most significant bit of the chain data is on the Q output pin of the first D flip flop 201 respectively. The chain data (the security data and the checker patterns) may be done loading to the security chain 130 at clock cycle 16.

In many embodiments in which the write-restricted memory 120 stores the data signature and the memory controller 160 transmits the data signature before the security data, the first bit (most/least significant bit) of the data signature may load to the input of the first flip flop 201 at clock cycle 0. Using the example above, where the chain data may be 16 bits long, and the data signature may be 4 bits long. At clock cycle 4, the four bits of the data signatures may be loaded to the outputs of flip flops 201-203, and the first bit of the chain data may be loaded at the input of the flip flop 201. As more clock cycles elapse, more bits of the chain data may be loaded to the security chain 130, and the data signature may be shifted further down the security chain 130. At clock cycle 16, the first bit of the data signature may be loaded to the output of the last flip flop 216. The memory controller 160 may couple to the Q output of the flip flop 216 to receive bits shifted down the security chain 130. At clock cycle 16, the memory controller 160 may receive the first bit of the data signature from the output of the last flip flop 216. At clock 17, the second bit of the data signature may be shifted down and may replace the first bit value at the output of the last flip flop 216. The memory controller 160 may receive the second bit of the data signature at clock 17. As the clock progresses, more bits of the data signature may be shifted down to the output of the last flip flop 216, and the memory controller 160 may receive all 4 bits of the data signature at clock cycle 20. At clock cycle 20, the chain data may be done loading to the security chain 130, with the first bit of the chain data transmitted stored at the output of the last flip flop 216, and the last bit of the chain data transmitted stored at the output of the first flip flop 201. The data signature bits may be transmitted via the security chain 130 to the memory controller 160, but the security chain 130 may not store the data signature bits.

Alternatively, the memory controller 160 may couple to a portion of the security chain 130 to receive the data signature of the security data. Using the example above that the data signature is 4 bits long, the memory controller 160 may couple to the first four flip flops 201-204 to receive the data signature. At clock cycle 4, all 4 bits of the data signature may be loaded to the outputs of the first four flip flops 201-204. The memory controller 160 may read the data signature at clock cycle 4 and may verify if the data signature read matches the data signature transmitted while the memory controller 160 continues to load the chain data to the security chain 130. If a mismatch of the data signature is detected, the memory controller 160 may stop the further loading of chain data to the security chain 130 and provide an indication to the processor 110 that a mismatch of data signature is detected. If the data signature received matches the data signature transmitted, the memory controller 160 may continue the loading process uninterrupted. In this manner, data signature checking is performed in parallel with chain data loading. Less clock cycles may be spent before a loading error is detected.

FIG. 2 illustrates flip flops 201-203, 208-211, and 215 (referred to as checker flops from here on) are loaded with checker patterns. The remaining flip flops 204-207, 212-214, and 216 (referred to as data flops from here on) are loaded with security data. For example, data flops 204-207 may be loaded with the four least significant bits of the security data at clock cycle 16 or clock cycle 20 if the data signature are also transmitted.

FIG. 2 illustrates examples with the security chain 130 with a total of 16 flip flops 201-216 including 8 data flops and 8 checker flops. Various embodiments of this invention may include any number of flip flops, including any number of data flops and any number of checker flops. The data flops and the checker flops may be at any locations within the security chain 130.

As described in the above example, at clock cycle 16 or clock cycle 20, the chain data may have been loaded into the security chain 130. The memory controller 160 may include a counter coupled to the shared clock of the flip flops 201-216 to count how many clock cycles have elapsed. In the examples illustrated by FIG. 2, the memory controller 160 may provide an indication (e.g., 1) on the load done signal to the logic circuitry 170 as describe above after the counter reaches a value of 16 or 20, indicating that the chain data has done loading to the security chain 130.

In the above examples that the data signature and the chain data are transmitted to the security chain 130, when the counter reaches the value of 20, the first bit of the chain data transmitted via the output of the mux 250 to the security chain 130, either the most significant bit or the least significant bit of the chain data, may be shifted to the Q output of the last flip flop 216. The memory controller 160 may receive the data signature and the first bit of the chain data and compare those received bits with the data signature and the first bit of the chain data transmitted to verify if any errors have occurred while loading to the security chain 130. If the bits (data signature and the first bit of the chain data) received match the bits transmitted, as described above, the memory controller 160 may provide an indication (e.g., 1) of error free on the load error signal to the logic circuitry 170, indicating that no errors have occurred. If no match exists, the memory controller 160 may provide an indication (e.g., 0) on the load error signal to the logic circuitry 170, indicating that an error has occurred. Alternatively, the memory controller 160 may verify the data signature transmitted and received, but not the first bit of the chain data. In many other examples, the memory controller 160 may verify the first bit of the chain data transmitted and received, but not the data signature.

The pattern checker 150 may couple to Q outputs of the checker flops in the security chain 130 to verify if the checker patterns stored in the security chain 130 match with the checker patterns generated by the pattern generator 140. In examples illustrated by FIG. 2, at clock cycle 16 or 20 (16 if no data signature, 20 if data signature is transmitted to the security chain 130 before the chain data is transmitted), when the chain data is loaded to the security chain 130, checker patterns may be loaded at the Q output of the checker flops. The pattern checker 150 may either receive the load done signal from the memory controller 160, or includes a counter that has counted 16 or 20 clock cycles elapsed as an indicator of the chain data has done loading to the security chain 130. The pattern checker 150 may subsequently read the outputs of the checker flops to verify if checker patterns loaded to the security chain 130 match with the checker patterns generated by the pattern generator 140. Even though checker patterns are generated independently of the contents of security data, whether the checker patterns generated by the pattern generator 140 match the checker patterns received by the pattern checker 150 provides an indication of whether the security data is stored correctly in the security chain 130. If the checker patterns generated match the checker patterns received, the pattern checker 150 may provide an indication (e.g., 1) that the security data is stored correctly in the security chain 130 on the pattern match signal to the logic circuitry 170. If a match between the checker patterns does not exist, the pattern checker 150 may provide an indication (e.g., 0) of security data comprised on the pattern match signal to the logic circuitry 170. The pattern checker 150 may not couple to the data flops to include less connections, to simply device architecture, and to save valuable device space.

Similarly, the processor 110 may couple to Q outputs of the data flops in the security chain 130 to read the security data. In examples illustrated by FIG. 2, at clock cycle 16 or 20, when the chain data is stored in the security chain 130, the security data may be loaded at the Q output of the data flops. The processor 110 may either receive the load done signal from the memory controller 160, or includes a counter that has counted 16 or 20 clock cycles elapsed as an indicator of the chain data being loaded to the security chain 130. The processor 110 may subsequently read the outputs of the data flops for the security data. The processor 110 may not couple to the checker flops to include less connections, to simply device architecture, and to save valuable device space. This may also prevent a user from executing malicious code intended to expose the checker pattern.

The logic circuitry 170 may receive the three status signals, the load done signal, the load error signal, and the pattern match signal, and transmit the load good signal to the processor 110 as described above with respect to FIG. 1. The processor 110 may continue/stall boot process in response to the load good signal. With this disclosure, the intruder may not gain access to sensitive data that devices are configured to handle by forcing 0s on the security chain 130. This invention provides enhanced protection to devices.

The logic circuitry 170 may be implemented in hardware/software to generate the load good signal. Alternatively, the processor 110 may receive the three status signals individually and may include internal/external logic implemented in hardware/software to execute instructions, or continue/stall boot process in response to the three status signals received.

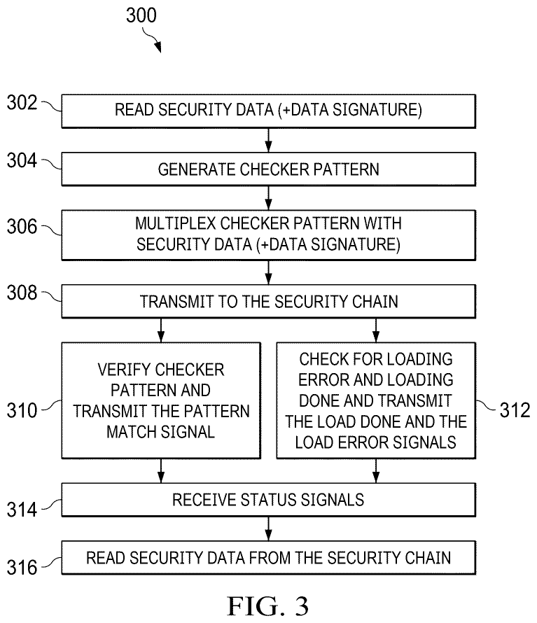

FIG. 3 illustrates a flow chart of a method 300 for providing enhanced protection to devices. Method 300 may be performed by the device 100 as illustrated in FIG. 1 and FIG. 2. The method described herein may include more, fewer, or other blocks. Additionally, the blocks may be performed in any suitable order. The method 300 may start at block 302.

At block 302, the memory controller 160 may receive a read request from the processor 110. The read request may include an indication of a data source to be read, such as the write-restricted memory 120. The read request may further include an indication of loading the security data into the security chain 130. The memory controller 160 may read the security data from the write-restricted memory 120 in response to the read request from the processor 110. In embodiments, where the write-restricted memory 120 also stores the data signature of the security data, the memory controller 160 may also read the data signature.

The method 300 may continue to block 304. At block 304, the pattern generator 140 may generate checker patterns to be multiplexed with the security data, for example, by the mux 250. The pattern generator 140 may generate fixed, random, and/or algorithm/sequence specific checker patterns as described above. In many examples, block 304 may be performed independently of block 302, or according to certain timing sequence. For example, when the processor 110 transmits the read request to the memory controller 160, the processor 110 may also provide an indication to the pattern generator 140 to start generating checker patterns. Alternatively, the memory controller 160 may provide an indication to the pattern generator 140 to start generating checker patterns when the memory controller 160 starts reading from the write-restricted memory 120. In other examples, the pattern generator 140 may start generating checker patterns at power on when it receives power above a certain threshold.

Method 300 may continue to block 306. At block 306, the mux 250 may multiplex the checker patterns and the security data to load to the security chain 130. FIG. 2 illustrates the memory controller 160 providing the security data to input 0 of the mux 250, and the pattern generator 140 provides checker patterns to input 1 of the mux 250. In many examples, the pattern generator 140 may also provide a select signal to the mux 250. The pattern generator 140 may select input 1 when checker patterns may be transmitted from the mux 250 to the security chain 130 or may select input 0 when the security data may be transmitted from the mux 250 to the security chain 130. In embodiments in which the data signature may also be transmitted via the security chain 130 to the memory controller 160, the pattern generator 140 may select input 0 of the mux 250 (the memory controller 160) for the number of clock cycles to load the data signature to the security chain 130 before the loading of the chain data as described above. Alternatively, the memory controller 160 may provide the select signal to the mux 250 to select between input 0 and input 1 when the data signature and/or the security data or checker patterns may be transmitted from the mux 250 to the security chain 130 respectively. Various embodiments are described above on providing the data signature and/or the security data and checker patterns to inputs of the mux 250 so that the data signature and/or the security data and checker patterns are multiplexed as desired. FIG. 2 illustrates examples where the memory controller 160 is connected to input 0 and the pattern generator 140 is connected to input 1 of the 2-input mux 250. However, other examples of this disclosure may also include multiplexers with any number of inputs, and the memory controller 160 and the pattern generator 140 couple to any inputs of the multiplexer. The multiplexer may also be implemented by any hardware/software components/logics to achieve the desired multiplexing of the security data and the checker patterns.

Method 300 may continue to block 308. At block 308, the data signature and/or security data and the checker patterns may be multiplexed by the mux 205 as the chain data to be transmitted from output of the mux 250 to the security chain 130. As shown in FIG. 2, many embodiments in accordance with this disclosure includes a shift register. The shift register may include any number of flip flops. The output of the mux 250 may couple to the input of the first flip flop 201 in the security chain 130. The mux 250 may transmit a first bit (either the most significant bit or the least significant bit) of the data signature to the input of the first flip flop 201 at clock 0. The first flip flop 201 may take one clock cycle to pass the first bit from its input to its output. At clock 1, the first bit may be on the output of the first flip flop 201, and a second bit of the data signature may be transmitted from the output of the mux 250 to the input of the first flip flop 201.

The flip flops in the security chain 130 may be connected serially (the output of the previous flip flop is connected with the input of the current flip flop). Continuing with the above example, the output of the first flip flop 201 is connected with the input of the second flip flop 202, so the first bit that is on the output of the first flip flop 201 may also be on the input of the second flip flop 202. At clock 2, the first bit may be shifted down to the output of the second flip flop 202 (input of the third flip flop 203), while the second bit may be shifted down to the output of the first flip flop 201 (input of the second flip flop 202) and the third bit may be loaded from the output of the mux 250 to the input of the first flip flop 201. Bits from the data signature followed by the chain data may follow this same scheme as described above to be loaded to the security chain 130.

FIG. 2 illustrates the security chain 130 including 16 flip flops (the chain data may be 16-bit long). At clock 16, the first bit of the data signature may be loaded to the output of the last flip flop 216, and 12 bits of the chain data may be loaded to the outputs of flip flops 201-212, with the thirteenth bit of the chain data loaded to the input of the first flip flop 201. The memory controller 160 may receive the first bit of the data signature at clock 16 by coupling to the output of the last flip flop 216. At clock 20, the chain data may be fully loaded to the security chain 130 with the first bit of the chain data stored at the output of the last flip flop 216 and the last bit of the chain data stored at the output of the first flip flop 201. The memory controller 160 may receive the four bits of the data signature even though the security chain 130 does not store the data signature. Embodiments illustrated in FIG. 2 includes D flip flops. However, other examples of this disclosure may include any other types of flip flops/latches or components/logics shift and store bits in a chain as described above. Alternatively, the memory controller 160 may couple a subset of the flip flops 201-216 to receive the four bits of the data signature as described above. The subset of the flip flops 201-216 may include any four flip flops of flip flops 201-216, and the memory controller 160 may read the data signature at corresponding clock cycles. For example, if the memory controller 160 couple to the outputs of flip flops 205-208, the memory controller may read the data signature at clock 8, when the data signature is loaded to the outputs of the flip flops 205-208.

Method 300 may continue to blocks 310 and 312 after the chain data is loaded to the security chain 130. The pattern checker 150 may couple to outputs of the checker flops (flip flops loaded with checker patterns as described above). In the examples shown in FIG. 2, with a 16-bit long chain data, a 4-bit data signature, and 16 flip flops included in the security chain 130, block 310 may be performed on or after clock cycle 20. At block 310, the pattern checker 150 may read the checker patterns stored on the outputs of the checker flops and compare those checker patterns with the checker patterns generated by the pattern generator 140. If these two checker patterns match, the pattern checker 150 may provide an indication (e.g., 1) of the security data stored correctly in the security chain 130 on the pattern match signal. If these two checker patterns do not match, the pattern checker 150 may provide an indication (e.g., 0) of the security data comprised in the security chain 130 on the pattern match signal.

At block 312, when the chain data has been loaded to the security chain 130, the memory controller 160 may transmit the load done signal. As illustrated in FIG. 2 where the chain data is 16 bits long and the data signature is 4 bits long, the memory controller 160 may count clock cycles and provide an indication (e.g., 1) on the load done signal once the memory controller 160 has counted to 20 clock cycles.

The memory controller 160 may verify the data signature to provide an indication of whether data loaded to the security chain 130 is compromised. In examples illustrated in FIG. 2, at clock 20, the memory controller 160 has received the data signature from the security chain 130. At block 312, which may be performed on or after clock cycle 20, the memory controller 160 verifies if the data signature transmitted matches the data signature received. If these two data signatures match, the memory controller 160 may provide an indication (e.g., 1) on the load error signal. If these two data signatures do not match, the memory controller 160 may provide an indication (e.g., 0) on the load error signal.

The method 300 may continue to block 314. At block 314, certain logic gates (e.g., logic circuitry 170) may receive the three status signals, the load done signal, the load error signal, and the pattern match signal and transmit the load good signal based on those three status signals. The logic gates may transmit the load good signal to the processor 110 to indicate whether any errors are detected when the chain data is loaded to the security chain 130. Alternatively, the processor 110 may receive those three status signals individually and execute instructions, or continue/stall boot processes in response to receiving those three status signals.

The method 300 may continue to block 316. At block 316, the processor 110, which may couple to the outputs of the data flops (flip flops that are loaded with security data as described above), may read the security data from the data flops if the processor 110 receives the indication that no errors occurred during loading of the chain data to the security chain 130. The processor 110 may not read the security data if the processor 110 receives indication that errors are detected during chain data loading to the security chain 130. Alternatively, block 316 may be performed at the same time with blocks 310 and/or 312. The processor 110 may read the security data from the security chain 130 once the processor 110 receives the load done signal from the memory controller 160, or the processor 110 may count 16 or 20 clock cycles and read the security data subsequently. If the processor 110 receives indication that errors are detected by either receiving the load good signal or receiving the three status signals individually, the processor 110 may disregard the security data read and stop the device 100 from booting.

In this regard, if the intruder trying to gain access to devices (e.g., the device 100) by forcing 0s on the security chain 130, the pattern checker 150 may detect mismatch and transmit indication to the processor 110. The processor 110 may stall boot process, reset, and/or shut down the device 100 to deny access to the intruder.

This invention disclosure is described with context of providing enhanced protection against intruders trying to gain access to devices. However, the scope of this invention also includes applications in any other fields that need data protection and/or verification.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

What is claimed is:

1. A device, comprising:
a set of registers;
a first circuit configurable to transmit a first set of data to a first subset of the set of registers;
a second circuit configurable to transmit a second set of data to a second subset of the set of registers wherein the first set of data is independent of the second set of data; and
a third circuit coupled to the first subset of the set of registers, and configurable to:
receive a third set of data from the first subset of the set of registers;
compare the third set of data to the first set of data; and
provide a first indication of whether the second set of data is stored in the second subset of the set of registers based on whether the third set of data matches the first set of data.

2. The device of claim 1, wherein the second circuit is configurable to:
couple to a third subset of the set of registers;
transmit a fourth set of data to the third subset of the set of registers, wherein the fourth set of data is associated with the second set of data;
receive a fifth set of data from the third subset of the set of registers;
compare the fifth set of data to the fourth set of data; and
provide a second indication of whether the second set of data is stored in the second subset of the set of registers based on whether the fifth set of data matches the fourth set of data.

3. The device of claim 1, comprising a read-only memory (ROM) configurable to store the second set of data, wherein the second circuit is configurable to read the second set of data from the ROM.

4. The device of claim 1, comprising a multiplexer coupled to the first circuit, the second circuit and the set of registers, wherein the multiplexer is configurable to multiplex the first set of data with the second set of data.

5. The device of claim 1, wherein the set of registers comprises a set of shift registers.

6. The device of claim 1, wherein the set of registers comprises a set of flip flops.

7. The device of claim 1, comprising a processor configurable to execute a first set of instructions based on the second set of data in response to the indication that the third set of data matches the first set of data.

8. The device of claim 7, wherein the processor is configurable to execute a second set of instructions in response to the indication that the third set of data does not match the first set of data.

9. The device of claim 7, wherein the second set of data comprises data related to booting of the processor.

10. The device of claim 7, comprising a set of logic gates coupled to the third circuit and configurable to provide a third indication of whether the second set of data is stored in the second subset of the set of registers to the processor based on the first indication.

11. The device of claim 10, wherein the set of logic gates comprises an AND gate.

12. A method, comprising:
transmitting a first set of data to a first subset of a set of registers;
reading a second set of data from a memory, wherein the first set of data is independent of the second set of data;
transmitting the second set of data to a second subset of the set of registers;
receiving a third set of data from the first subset of the set of registers;
comparing the third set of data to the first set of data;
providing a first indication of whether the second set of data is stored in the second subset of the set of registers based on whether the third set of data matches the first set of data.

13. The method of claim 12, comprising:
transmitting a fourth set of data to a third subset of the set of registers, wherein the fourth set of data is associated with the second set of data;
receiving a fifth set of data from the third subset of the set of registers;
comparing the fifth set of data to the fourth set of data; and
providing a second indication of whether the second set of data is stored in the second subset of the set of registers based on whether the fifth set of data matches the fourth set of data.

14. The method of claim 12, wherein the memory comprises a read-only memory (ROM).

15. The method of claim 12, comprising multiplexing the first set of data with the second set of data.

16. The method of claim 12, wherein the set of registers comprises a set of shift registers.

17. The method of claim 12, wherein the set of registers comprises a set of flip flops.

18. The method of claim 12, comprising:
in response to the third set of data matching the first set of data, executing a first set of instructions by a processor based on the second set of data.

19. The method of claim 12, comprising:
in response to the third set of data not matching the first set of data, executing a second set of instructions by a processor.

20. The method of claim 19, wherein the first set of data comprises data related to booting of the processor.

21. The method of claim 19, comprising, providing a third indication of whether the second set of data is stored in the second subset of the set of registers by a set of logic circuits to the processor based on the first indication.
